(19) United States
(12) Patent Application Publication
(10) Pub. No.: US 2016/0303625 A1
(43) Pub. Date: Oct. 20, 2016

(54) HEAT TRAVEL DISTANCE

(71) Applicant: RETERRO, Pleasanton, CA (US)

(72) Inventors: Brian Desmarais, Pleasanton, CA (US); Steve Bay, Pleasanton, CA (US)

(21) Appl. No.: 15/130,896

(22) Filed: Apr. 15, 2016

Related U.S. Application Data
(60) Provisional application No. 62/148,142, filed on Apr. 15, 2015.

(51) Int. Cl. B09C 1/06

(52) U.S. Cl. CPC B09C 1/06

(57) ABSTRACT

This described invention related generally to thermal desorption systems. In one example embodiment, to methods, apparatus, and systems to a soil box design of thermal desorption system, wherein the soil box realizes a design for efficient heating and removing of containments such as hydrocarbons from contaminated soil by minimizing a distance between a point of treatment gas insertion and another point of treatment gas exit.

This application claims priority from provisional patent application Ser. No. 62/148,142, filed on Apr. 15, 2015, entitled “Heat Travel Distance”, which applications are incorporated herein by reference in their entirety for all purposes.

### FIELD OF TECHNOLOGY

This disclosure relates generally to thermal desorption systems, in one example embodiment, to methods, apparatus, and systems to a soil box design of thermal desorption system.

### BACKGROUND

In many fields, even with stringent use, quality, transportation and environmental controls, spillage and contamination of environment harming substances, may be inevitable especially in fields with the use of petroleum hydrocarbons. In these fields, petroleum hydrocarbon products are stored and handled in great quantities. One risk associated with the storage and handling of petroleum hydrocarbons may be the potential for spillages during handling or the potential for leakage during storage or use. Due to the negative environmental impact associated with spills and leakages of petroleum hydrocarbons, rules have been established at the local, state and federal levels. These rules primarily focus on preventing petroleum hydrocarbon releases to the environment from occurring. However, contamination still occurs, and as such, the rules also have provisions that require the responsible party to remediate petroleum hydrocarbon releases to the environment to certain standards. In addition, industry produces hazardous waste that requires treatment prior to landfill disposal to meet land disposal restrictions. For example, gravity separated solids generated at an oil refineries require treatment to universal treatment standards prior to land disposal.

In the field of petroleum hydrocarbon remediation from soil, there are two basic approaches: applying a treatment technique to soil in place (in-situ), or applying a treatment technique to excavated soil (ex-situ). There are advantages and disadvantages for each approach and the selection of the approach may be based on the site-specific circumstances of each petroleum hydrocarbon release.

Ex-situ thermal desorption technologies can include techniques that involve mechanical agitation of the soil during the heating process, which involve mechanical agitation and operate in a continuous process where the soil may be continuously introduced to the process and may be mechanically moved through the process apparatus until treatment may be complete, and then may be continuously discharged to a container for disposal or re-use.

Alternately, the soil can be treated in a static configuration, in which a given amount of soil may be introduced to the treatment chamber. The soil configurations can include pile arrangement and container arrangements.

Nearly all the prior art processes use combustion of fossil fuel as a heat source. This can have the undesirable consequence of forming products of incomplete combustion, oxides of nitrogen, and other greenhouse gases as a by-product. Combustion also has the potential to add unburned hydrocarbons to the process exhaust gas if strict control of the combustion process may be not maintained. Some prior art use direct open flame treatment of which provides many problems including incomplete combustion, combustion of materials within the treated materials, and many other hazards and inefficiencies.

The aforementioned thermal desorption processes, as well as many other prior art processes are inefficient at transferring heat to the soil in a uniform and necessary manner as the soil itself does not provide the optimal surface area or characteristics to be heated, especially when treated in a treatment container. The aforementioned techniques using mechanical agitation are also inefficient and complex for many reasons such as necessitating further moving parts that must be serviced as well as made, making the process expensive, unreliable, and inefficient.

As such, a need for an ex-situ treatment box method that provides for an ability to transfer heat to remediate soil in a cost-effective, efficient and time sensitive manner is needed.

### SUMMARY

Disclosed are methods, apparatus, and systems to treat contaminated soil. As disclosed herein, the present invention discloses a soil box design of a thermal desorption system.

The present invention in a preferred embodiment may comprise an ex-situ thermal desorption system or method to remediate contaminants. The present invention then may present a soil treatment box of any shape and size, of which may have any plurality of zones. This treatment box, may have a removable or moveable top, side, bottom or door on any side of the box, of which soil to be treated may be added or removed from.

The soil treatment box may then introduce a heated, by any means, gas, of which may be any type of gas, to the soil, such that in one embodiment the gas may directly contact the soil to transfer heat and provide for other characteristics, or in another embodiment the gas indirectly contacts the soil to transfer heat and provide for other characteristics. The heat then may either evaporate or desorb contaminants in the soil, via properties of the heat itself, or by reactions catalyzed by the heat. In the direct contact embodiment, the gas itself may help catalyze or desorb or evaporate contaminants.

The treatment gas entry points, may be positioned in a fashion, wherein the distance between the exit and entrance points may be minimized, such that the heat transfer and permeation through the soil may be efficient and complete. In an embodiment, pipes may run across in any direction, with any shape size, geometry and plurality, the treatment box interior recess such that the pipes contact the soil and wherein the heat from the treatment traveling through the pipes, may transfer heat to the pipes, and then into the soil. In the direct contact method there may be perforations in the pipes, such that the treatment gas may permeate into the soil, and travel through the soil, where the heat and gas may desorb and evaporate contaminants, of which then may travel to exit points or exit pipes with perforations, at any point along the pipe, such as the ends, and be then excavated or pushed out form the treatment soil box. In the indirect method, as well as the direct method, the evaporated and desorbed contaminants may be removed from exit points along the periphery of the soil box, such as a hood on the upper portion of the box, such that the contaminants are removed from the soil and soil treatment box.

The contaminants of which may be removed, may be vented to the ambient, treated and then vented to the atmosphere, or otherwise or transferred for treatment.

Thus the present invention provides for a cost effective ex-situ treatment soil box, wherein the exit and entry points for the treatment gas ire ionized allowing for complete and efficient heat transfer and desorption/evaporation of contaminants in the soil box.

In this aspect, such programs may comprise instructions to implement the methods described heretofore.

The methods and systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, in which, like references indicate similar elements.

FIG. 1A-1B teaches to side perspective views of embodiments of the present invention ex-situ soil treatment box.

FIG. 2A-2B teaches to a side perspective view of embodiments of the present invention ex-situ soil treatment box.

FIG. 3 teaches to a side perspective cross-section of the present invention ex-situ soil treatment box

FIG. 4 teaches to a side view of the exterior of an embodiments of the present invention ex-situ soil treatment box

FIG. 5 teaches to another side view the exterior of an embodiment of the present invention ex-situ soil treatment box.

FIG. 6 teaches to a perspective of the exterior of an embodiment of the present invention ex-situ soil treatment box.

FIG. 7 teaches to a side view cross-section of an embodiment of the present invention ex-situ soil treatment box.

FIGS. 8A-8B teaches to a flow study diagram of the present invention ex-situ soil treatment box showing treatment gas flowing through the pipes on the interior of the box.

FIG. 9 teaches to an alternate flow study diagram of the present invention ex-situ soil treatment box.

FIG. 10 teaches to a cross section of the present invention ex-situ soil treatment box.

Other features of the present embodiments will be apparent from the accompanying drawings and from the detailed description that follows.

### DETAILED DESCRIPTION

Disclosed are methods, apparatus, and systems to treat contaminates from contaminated earth. Although the present embodiments have been described with reference to specific example embodiments, it will be evident that various modifications and changes may be made to these embodiments without departing from the broader spirit and scope of the various embodiments. In addition, the components shown in the figures, their connections, and their functions, are meant to be exemplary only, and are not meant to limit the embodiments described herein.

Disclosed are methods, apparatus, and systems to treat contaminated soil. As disclosed herein, the present invention discloses a soil box design of a thermal desorption system.

In one or more embodiments, which may be in addition or combination to any other embodiments, the present invention may comprise an ex-situ thermal desorption system or method.

In one or more embodiments, which may be in addition or combination to any other embodiments, the present invention may comprise an ex-situ thermal desorption system or method for any type of soil.

In one or more embodiments, which may be in addition or combination to any other embodiments, the present invention may comprise an ex-situ thermal desorption system or method for any type of soil such as a porous media.

In one or more embodiments, which may be in addition or combination to any other embodiments, the present invention may comprise an ex-situ thermal desorption system or method for any type of soil such as a non-porous media.

In one or more embodiments, which may be in addition or combination to any other embodiments, the present invention may comprise an ex-situ thermal desorption system or method to remediate contaminants.

In one or more embodiments, which may be in addition or combination to any other embodiments, the present invention may comprise an ex-situ thermal desorption system or method to remediate contaminants such as hydrocarbons.

In one or more embodiments, which may be in addition or combination to any other embodiments, the present invention may comprise an ex-situ thermal desorption system or method to remediate contaminants such as hydrocarbons wherein the thermal desorption heat provided may be indirect.

In one or more embodiments, which may be in addition or combination to any other embodiments, the present invention may comprise an ex-situ thermal desorption system or method to remediate contaminants such as hydrocarbons wherein the thermal desorption heat provided may be flameless.

In one or more embodiments, which may be in addition or combination to any other embodiments, the present invention may comprise an ex-situ thermal desorption system or method to remediate contaminants such as hydrocarbons wherein the thermal desorption heat may be provided indirectly from an indirectly heated gas.

In one or more embodiments, which may be in addition or combination to any other embodiments, the present invention may comprise an ex-situ thermal desorption system or method to remediate contaminants such as hydrocarbons wherein the thermal desorption heat may be provided directly from an indirectly heated gas

In one or more embodiments, which may be in addition or combination to any other embodiments, the present invention may comprise an ex-situ thermal desorption system or method to remediate contaminants such as hydrocarbons wherein the thermal desorption heat may be provided from a directly heated gas.

In one or more embodiments, which may be in addition or combination to any other embodiments, the present invention may comprise an ex-situ thermal desorption system or method to remediate contaminants such as hydrocarbons wherein the thermal desorption heat may be provided into the soil by a forced gas.

In one or more embodiments, which may be in addition or combination to any other embodiments, the present invention may comprise an ex-situ thermal desorption system or method to remediate contaminants such as hydrocarbons wherein the soil to be treated may be held in a soil treatment box, of which may be of any size, shape or geometry, but most commonly may be a rectangular prism, of which may contain the soil.

In one or more embodiments, which may be in addition or combination to any other embodiments, the present invention may comprise an ex-situ thermal desorption system or method to remediate contaminants such as hydrocarbons wherein the soil to be treated may be held in a soil treatment box, of which may be of any size, shape or geometry, and of which may have a removable or otherwise open-able top, bottom or side, of which allows for the ease of removal and loading of the soil.

In one or more embodiments, which may be in addition or combination to any other embodiments, the present invention may comprise an ex-situ thermal desorption system or method to remediate contaminants such as hydrocarbons wherein the soil to be treated may be held in a soil treatment box of which may have dividers within the interior recess to break the interior into more than one zone, such as to be able to remediate two different types of soil and keep them separately, or provide for two areas, wherein the soils may be of different contaminants or contaminant levels. Another instance may be that there may not enough soil to be processed to fill the entire box, and as such only a smaller zone may be used to not waste heat heating the recess, which does not contain soil.

In one or more embodiments, which may be in addition or combination to any other embodiments, the present invention may comprise an ex-situ thermal desorption system or method to remediate contaminants such as hydrocarbons wherein the thermal desorption heat may be provided into the soil by an indirectly heated forced gas, wherein the gas may be indirectly heated by any method, such as an indirect flame, or by electric heating elements, and wherein the gas may be then heated, and then via any method, forced into the treatment box to directly or indirectly contact the soil to be treated.

In one or more embodiments, which may be in addition or combination to any other embodiments, the present invention may comprise an ex-situ thermal desorption system or method to remediate contaminants such as hydrocarbons wherein the thermal desorption heat may be provided into the soil by an indirectly heated forced gas, wherein the gas may be indirectly heated by any method, such as an indirect flame, or by electric heating elements.

In one or more embodiments, which may be in addition or combination to any other embodiments, the present invention may comprise an ex-situ thermal desorption system or method to remediate contaminants such as hydrocarbons wherein the thermal desorption heat may be provided into the soil by a heated gas, wherein the gas may be of any temperature.

In one or more embodiments, which may be in addition or combination to any other embodiments, the present invention may comprise an ex-situ thermal desorption system or method to remediate contaminants such as hydrocarbons wherein the thermal desorption heat may be provided into the soil by a heated gas, wherein the gas may be of any composition, such as ambient air or desiccated air, or a specific gas which may have a specific property that may aid in the desorption, evaporation or other intended process of the contamination remediation. An example can be a gas that transfer heat to the pipes efficiently, such that the soil in contact or proximity with the pipes may be heated

In one or more embodiments, which may be in addition or combination to any other embodiments, the present invention may comprise an ex-situ thermal desorption system or method to remediate contaminants such as hydrocarbons wherein the heated gas then via any method may be forced into the treatment box to directly or indirectly contact the soil to be treated.

In one or more embodiments, which may be in addition or combination to any other embodiments, the present invention may comprise an ex-situ thermal desorption system or method to remediate contaminants such as hydrocarbons wherein the heated gas then via any method may be forced into the treatment box to indirectly contact the soil, such as through heating the soil box structures of which then may heat the soil and evaporate or desorb the contaminants such as the hydrocarbons, of which may be then vented or vented to be treated.

In one or more embodiments, which may be in addition or combination to any other embodiments, the present invention may comprise an ex-situ thermal desorption system or method to remediate contaminants such as hydrocarbons wherein the heated gas then, via any method, may be forced into the treatment box to directly contact the soil to be treated and of which may heat the soil which aids the evaporation or desorption of the contaminants such as hydrocarbons, of which then the forced air and contaminants are then vented to be treated or vented to the ambient.

In one or more embodiments, which may be in addition or combination to any other embodiments, the present invention may comprise an ex-situ thermal desorption system or method to remediate contaminants such as hydrocarbons wherein the heated gas may be inserted into the treatment chamber to treat the soil.

In one or more embodiments, which may be in addition or combination to any other embodiments, the present invention may comprise an ex-situ thermal desorption system or method to remediate contaminants such as hydrocarbons wherein the heated gas may be inserted at one point into the treatment chamber to treat the soil.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil.

In one or more embodiments, which may be in addition or combination to any other embodiments, the present invention may comprise an ex-situ thermal desorption system or method to remediate contaminants such as hydrocarbons wherein the heated gas and desorbed or evaporated may exit the treatment chamber at one point either together or separately, respectively.

In one or more embodiments, which may be in addition or combination to any other embodiments, the present invention may comprise an ex-situ thermal desorption system or method to remediate contaminants such as hydrocarbons wherein the heated gas and desorbed or evaporated contaminants exit the treatment chamber at plurality of points.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants exit at a plurality of points.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants exit at a plurality of points, wherein the plurality of insertion points are at a specific distance from respective exit points.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants exit at a plurality of points, wherein the plurality of insertion points are at a specific distance from respective exit points, and wherein the distance may be minimized.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants may exit at a plurality of points, wherein the plurality of insertion points may be at a specific distance from respective exit points, and wherein the distance may be an efficient distance or designed for a specific characteristic, such as temperature difference between the insertion points and exit points.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants may exit at a plurality of points, wherein the plurality of insertion points and exit points may be designed or structured for a specific characteristic, such as the design minimizes the average distance between the plurality of insertion points and respective exit points.

In one or more embodiments, which may be in addition or combination to any other embodiments, the present invention may comprise an ex-situ thermal desorption system or method to remediate contaminants such as hydrocarbons wherein the heated gas may be inserted to or exited from the soil treatment box at one or more than one points, wherein the insertion and exit points include a pipe that penetrates at least partially into the interior box area, or the pipe traverses from one side of the box to the other, wherein the pipe carries hot gas, and of which the pipe may be of any geometry or shape such as a cylindrical or rectangular pipe.

In one or more embodiments, which may be in addition or combination to any other embodiments, the present invention may comprise an ex-situ thermal desorption system or method to remediate contaminants such as hydrocarbons wherein the heated gas may be inserted to or exited from the soil treatment box at one or more than one point, wherein the insertion and exit points include a pipe that penetrates at least partially into the interior box area, or the pipe traverses from one side of the box to the other, wherein the pipe carries hot gas from one side of the box to another, and wherein one side of the pipe may be the entry point and the other side of the pipe, on the opposite side of the box may be the exit point. In the indirect method, the pipe may be sealed and as such the treatment gas solely travels through, radiating heat to the pipe, and then to the soil.

In one or more embodiments, which may be in addition or combination to any other embodiments, the present invention may comprise an ex-situ thermal desorption system or method to remediate contaminants such as hydrocarbons wherein the heated gas may be inserted to or exited from the soil treatment box at one or more than one points, wherein the insertion and exit points include a pipe that penetrates at least partially into the interior box area, or the pipe traverses from one side of the box to the other, wherein the pipes are arranged in pattern such that on each side of the soil box may have all entry point, all exit point, or a randomized, or selected pattern, such as every other pipe, may be entry point and exit points alternating, such that the heat from the gas may be even distributed evenly throughout the soil and treatment box. It is noted that this may provide for an even heat as the treatment gas loses temperature as it travels through the pipe or soil box, and thus alternating insertion and exit points, allows an even heat to be given over a given area.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, or the pipe traverses from one side of the box to the other, and wherein the pipes are horizontal across the treatment box relative to an axis.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, or the pipe traverses from the top to the bottom of the box or vice-versa, and wherein the pipes are vertical across the treatment box relative to an axis.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, or the pipe traverses from one side of the box to the other, where some of the pipes may be perpendicular.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, or the pipe traverses from one side of the box to the other, and wherein the pipes are horizontal and vertical across the treatment box relative to an axis, where some of the pipes may be perpendicular to each other.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, and wherein the pipes are of any plurality, size shape and diameter.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, and wherein the pipes are vertical.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, and wherein the pipes are horizontal

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, and wherein the pipes and soil box itself are made of any material for a purpose, such as the pipes made of a material such as steel for longevity, or of aluminum or a composite for maximum heat transfer to the soil.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, wherein the pipe include perforations or holes, wherein the gas may escape from the pipe and permeate into the soil in insertion pipes, and vice versa, the exit pipes may include perforation, where the treatment gas, along with the desorbed and evaporated contaminants, may be forced to exit the treatment soil box.

In one or more embodiments, which may be in addition or combination to any other embodiments, the present invention may comprise an ex-situ thermal desorption system or method to remediate contaminants such as hydrocarbons wherein the heated gas be inserted to or exited from the soil treatment box at one or more than one points, wherein the insertion and exit points include a pipe that penetrates at least partially into the interior box area, and wherein the pipes may only traverse or effect one zone, if there are multiple zones of the soil treatment box. The pipes may also affect multiple are all zones, depending on the application. Additionally the pipes may be controlled or isolated such s for a certain effect for each zone. For instance, one zone may be more contaminated or require more heat and as such may be positioned immediately preceding the insertion point of the treatment gas in the pipe, while another zone that does not require as much heat may be situated on the exit side of the treatment gas pipe.

In one or more embodiments, which may be in addition or combination to any other embodiments, the present invention may comprise an ex-situ thermal desorption system or method to remediate contaminants such as hydrocarbons wherein the heated gas inserted into the treatment soil box and subsequently contacts and permeates the soil, may transfer heat, as well as excavate evaporated and desorbed contaminants to remove the contaminants from the soil and the soil treatment box.

In one or more embodiments, which may be in addition or combination to any other embodiments, the present invention may comprise an ex-situ thermal desorption system or method to remediate contaminants such as hydrocarbons wherein the heated gas inserted into the treatment soil box and subsequently contacts and permeates the soil, may transfer heat, as well as excavate evaporated and desorbed contaminants to remove the contaminants from the soil and the soil treatment box, wherein the distance between the insertion point of the gas and the exit point may be minimized due to the design of the insertion points and piping and exit points and piping.

In one or more embodiments, which may be in addition or combination to any other embodiments, the present invention may comprise an ex-situ thermal desorption system or method to remediate contaminants such as hydrocarbons wherein the heated gas inserted into the treatment soil box travels through the contained pipes through the interior of the soil box from insertion point to exit point, without directly contacting the soil.

In one or more embodiments, which may be in addition or combination to any other embodiments, the present invention may comprise an ex-situ thermal desorption system or method to remediate contaminants such as hydrocarbons wherein the heated gas inserted into the treatment soil box travels through the contained pipes through the interior of the soil box from insertion point to exit point, wherein the pipe may be seamless, or alternatively may be made of sections, wherein the sections may traverse zones of the box differentiated by walls, wherein each section of the pipe is connected to the wall, and wherein the transfer of gas may be seamless between the sections, as the gas travels from one end of the box to the other.

In one or more embodiments, which may be in addition or combination to any other embodiments, the present invention may comprise an ex-situ thermal desorption system or method to remediate contaminants such as hydrocarbons wherein the heated gas inserted into the treatment soil box travels through the contained pipes and wherein in the indirect embodiment, pipes carry the gas in alternating directions to the respective proximate pipe.

In one or more embodiments, which may be in addition or combination to any other embodiments, the present invention may comprise an ex-situ thermal desorption system or method to remediate contaminants such as hydrocarbons wherein the heated gas inserted into the treatment soil box travels through the contained pipes and wherein in the direct embodiment, the pipe may be open on the insertion end, to allow gas to be introduced but closed on the alternate end, causing the gas to be forced into the soil box through perforations or recesses to interact with the soil, and wherein the proximate pipes may have alternating insertion point ends.

In one or more embodiments, which may be in addition or combination to any other embodiments, the present invention may comprise an ex-situ thermal desorption system or method to remediate contaminants such as hydrocarbons wherein the heated gas inserted into the treatment soil box travels through the contained pipes through the interior of the soil box from insertion point to exit point, without directly contacting the soil, wherein the heat of the gas transfers heat from the gas to the piping, and subsequently though any method, transfers heat to the soil and into the treatment box recess, wherein the heat transferred aids in desorption and evaporation of the contaminants to be removed.

In one or more embodiments, which may be in addition or combination to any other embodiments, the present invention may comprises an ex-situ thermal desorption system or method to remediate contaminants such as hydrocarbons wherein the heated gas inserted into the treatment soil box travels through the contained pipes through the interior of the soil box from insertion point to exit point, without directly contacting the soil, wherein the heat of the gas transfers heat from the gas to the piping, and subsequently though any method, transfers heat to the soil and into the treatment box recess and wherein the heat travels as a heat wave throughout the soil and soil treatment box, wherein the soil then becomes uniformly heated, or heated in a method, wherein by the end of the process, all the soil may be heated to a standard to assure proper evaporation and desorption of contaminants.

In one or more embodiments, which may be in addition or combination to any other embodiments, the present invention may comprise an ex-situ thermal desorption system or method to remediate contaminants such as hydrocarbons wherein the heated gas inserted into the treatment soil box to directly or indirectly contact the soil, and of which there are vents that capture or otherwise allow for the removal of the evaporated or desorbed contaminants from the treatment box.

In one or more embodiments, which may be in addition or combination to any other embodiments, the present invention may comprise an ex-situ thermal desorption system or method to remediate contaminants such as hydrocarbons wherein the heated gas inserted into the treatment soil box to directly or indirectly contact the soil, and of which there are vents that capture or otherwise allow for the removal of the evaporated or desorbed contaminants from the treatment box, wherein the vents are situated near the exit points for the treatment gas, whether the exit points are in the direct design (perforated pipes) or indirect design (non-perforated)

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants may exit at a plurality of points, wherein the plurality of insertion points and exit points may be designed or structured for a specific characteristic, such as to maximize the amount of heat transferred to the contaminated soil and contaminates, such that the contaminants may be desorbed or evaporated and may be separated from the soil and vented or removed from the soil or treatment box.

In one or more embodiments, which may be in addition or combination to any other embodiments, the present invention may comprise an ex-situ thermal desorption system or method to remediate contaminants such as hydrocarbons wherein the heated gas may be inserted at a plurality of points into the treatment chamber to treat the soil and wherein the heated gas with the desorbed or evaporated contaminants may exit at a plurality of points, wherein the plurality of insertion points and exit points may be designed or structured for a specific characteristic, such as to maximize the surface area or volume or other characteristic of the soil to the heated forced gas, such that the heated forced gas may aid in venting or removing the evaporated or desorbed contaminants from the soil and treatment box.

In one or more embodiments, which may be in addition or combination to any other embodiments, the present invention may comprise an ex-situ thermal desorption system or method to remediate contaminants such as hydrocarbons wherein the heated gas along with the evaporated or desorbed contaminants, after removal from the soil and treatment box may be vented to the atmosphere.

In one or more embodiments, which may be in addition or combination to any other embodiments, the present invention may comprise an ex-situ thermal desorption system or method to remediate contaminants such as hydrocarbons wherein the heated gas along with the evaporated or desorbed contaminants, after removal from the soil and treatment box may be treated, purified or otherwise processed.

In one or more embodiments, which may be in addition or combination to any other embodiments, the present invention may comprise an ex-situ thermal desorption system or method to remediate contaminants such as hydrocarbons wherein the heated gas along with the evaporated or desorbed contaminants, after removal from the soil and treatment box may be treated, purified or otherwise processed before being vented to the atmosphere.

In one or more embodiments, which may be in addition or combination to any other embodiments, the present invention may comprise an ex-situ thermal desorption system or method to remediate contaminants such as hydrocarbons wherein the heated gas along with the evaporated or desorbed contaminants, after removal from the soil and treatment box may be captured and stored or transported.

In one or more embodiments, which may be in addition or combination to any other embodiments, the present invention may comprise an ex-situ thermal desorption system or method to remediate contaminants such as hydrocarbons wherein the heated gas along with the evaporated or desorbed contaminants, after removal from the soil and treatment box may be captured and stored or transported in another system or offsite.

In one or more embodiments, which may be in addition or combination to any other embodiments, the present invention may comprise an ex-situ thermal desorption system or method to remediate contaminants such as hydrocarbons wherein the heated gas along with the evaporated or desorbed contaminants, after removal from the soil and treatment box may treated, purified or otherwise processed and then may be captured and stored or transported in another system or offsite. [94] In one or more embodiments, which may be in addition or combination to any other embodiments, the present invention may comprise an ex-situ thermal desorption system or method comprising of a soil box design.

In one or more embodiments, which may be in addition or combination to any other embodiments, the present invention may maximize the amount of contaminated soil processed in a batch, as Soil such as sediments, tar, and contaminates may be poor conductors of heat. By the aforementioned minimizing the distance between the point of treatment gas insertion and another point of treatment gas exit, the present invention may allow heat fronts to travel and process a maximum amount of the contaminated soil of a soil batch. The present invention then may solve the problem of incomplete treatment of a soil batch due to the poor heat conductivity of soil. Therefore, the present invention may increase efficiency over prior art by its having many heat front distances with minimal distances, which may be maximized by configuring multiple heat fronts with multiple exit pathways, thereby minimizing the aforementioned distance.

In one or more embodiments, which may be in addition or combination to any other embodiments, the present invention may comprise multiple heat fronts and multiple exit pathways may be arranged in a vertical direction or a horizontal direction. An example may be that the forced air, and subsequent heat front may be forced or inserted into the treatment box from a horizontal location on any end of the soil box, such that the heat front and an exit pathway may be achieve by either placing a single heat front and a single exit pathway in close proximity, or by designing the soil box to comprise of multiple heat fronts and multiple exit pathways positioned within equal distance and space apart from one another. Generally, the more heat fronts and pathways, the shorter the distance of travel.

In one or more embodiments, which may be in addition or combination to any other embodiments, the present invention may comprise that the heat fronts and exit pathways may be made from a rod structure, such as a well screen. The rod structure may be made from any metal, such as steel and aluminum. The size of the rod structure may be determined based on desirable operating conditions, such as flow and contact surface area.

In one or more embodiments, which may be in addition or combination to any other embodiments, the present invention may comprise that the heat fronts or insertion points and exit points or pathways may be made from a rod structure, such as a well-screen. The rod structure may penetrate into the treatment box and of which the rods may have a single opening, or many openings along their length, such that many heat fronts may exist and may insertion points for the heated gas exist.

In one or more embodiments, which may be in addition or combination to any other embodiments, the present invention may comprise of many subsequent exit points or pathways, such as rods that may penetrate into the treatment box, of which the rods may have a single opening, or many openings along their length, such that many exit points or pathways may exist for the gas and contaminants to exit the treatment box.

In one or more embodiments, which may be in addition or combination to any other embodiments, the present invention may introduce a high temperature gas, of which the temperature and oxidation reaction occurring within the soil bed can consume most if not all of the oxygen within the treatment gas throughout most of the treatment cycle. Thus, the treatment chamber can then be inherently safe, even with the use of high oxygen concentration treatment gas and high temperature, such using atmospheric air having oxygen concentration of 21%, to accelerate the treatment time and reduce downstream vapor processing equipment.

In one or more embodiments, which may be in addition or combination to any other embodiments, the present invention may comprise of systems methods and apparatuses to provide safe conveyance at the end of the treatment cycle, e.g., after the treatment gas leaves the soil box, since the hydrocarbon concentration within the soil bed significantly diminishes, and oxygen not consumed in the hydrocarbon oxidation can create an explosive mixture of hydrocarbon vapor and oxygen.

In one or more embodiments, which may be in addition or combination to any other embodiments, the temperature of the treatment gas and contaminants before insertion, after insertion in the treatment box, and after leaving the treatment chamber can be regulated to reduce or eliminate the potential hazard of auto-ignition. Additionally or alternatively, the section of the transferring structure for the gas may be immediately adjacent to the treatment chamber that can experience high temperature can be proofed against explosion, such as having isolation and pressure relief chimney, cooling assembly to lower the temperature of the e gas to below the auto-ignition temperature, and providing a porous flow condition to limit the propagation of flame or explosion fronts.

In one or more embodiments, which may be in addition or combination to any other embodiments, the evaporative desorption and/or reclamation process, can be cost effectively constructed to any scale and can exceed the 10 ton per hour production rate of indirect rotary kilns.

In one or more embodiments, which may be in addition or combination to any other embodiments, the present invention may use non-combustive heat in the treatment chamber.

In one or more embodiments, which may be in addition or combination to any other embodiments, the present invention may use combustive heat in the treatment chamber.

In one or more embodiments, which may be in addition or combination to any other embodiments, the present invention may provide efficient heat transfer to the soil/porous media such as through forced heated air and additional may provide ancillary heat to heat the soil/porous media through an reaction between the gas of which may be catalyzed by heat, such as an oxidation reaction between the contaminants and the heated forced air, that takes place for example, through hydrocarbon cracking that takes place within the crude oil contaminated soil.

In one or more embodiments, which may be in addition or combination to any other embodiments, the present invention may use both heat and reactions to minimize the energy required for treatment.

In one or more embodiments, which may be in addition or combination to any other embodiments, the present invention may use reactions, such as heat catalyzed reactions to breakdown contaminants to preferred substances that are either desired for being non-harmful or other properties, such as for ease of removal form the soil in a later process.

In one or more embodiments, which may be in addition or combination to any other embodiments, the present invention may use reactions, such as catalyzed or other reactions not only from the heat but also from or in combination from the direct contact of certain treatment gases that breakdown contaminants to preferred substances that are either desired for being non-harmful or other properties, such as for ease of removal form the soil in a later process.

In one or more embodiments, which may be in addition or combination to any other embodiments, the present invention may recycle its heated treatment gas supply, minimizing energy required for treatment.

In one or more embodiments, which may be in addition or combination to any other embodiments, the present invention may use fresh treatment gas.

In one or more embodiments, which may be in addition or combination to any other embodiments, the present invention may use a mixture of recycled and fresh treatment gas such as to provide for the most efficient operation.

In one or more embodiments, which may be in addition or combination to any other embodiments, the present invention may use a treatment box of any shape, size and volume.

In one or more embodiments, which may be in addition or combination to any other embodiments, the present invention may use a treatment box of any material.

In one or more embodiments, which may be in addition or combination to any other embodiments, the present invention may use a treatment box of that may be insulated, such as thermally insulted to provide for efficient operation.

In one or more embodiments, which may be in addition or combination to any other embodiments, the present invention may use a treatment box of that may use a treatment gas of any type.

In one or more embodiments, which may be in addition or combination to any other embodiments, the present invention may use a treatment box of that may use a treatment gas of any type such as ambient air.

In one or more embodiments, which may be in addition or combination to any other embodiments, the present invention may use a treatment box of that may use a treatment gas of any type such as heated gas.

In one or more embodiments, which may be in addition or combination to any other embodiments, the present invention may use a treatment box of that may use a treatment gas of any types such as a gas such as ambient air that has been or may be desiccated. An example can be ambient air that has been dehumidified to a certain humidity level such as below 40, 30, 20, and 10 or even below 5% relative humidity or absolute humidity.

In one or more embodiments, which may be in addition or combination to any other embodiments, the present invention may use a treatment box of that may use a treatment gas of fresh, recycled or a combination of fresh and recycled hot, desiccated air may be drawn through the soil treatment container to provide for treatment, and the excavated, cooled, and released; or discharged to a treatment system, as required or needed, prior to release to the atmosphere.

In a preferred embodiment, which may be in addition or combination to any other embodiments, the present invention may be a thermal desorption technique applied to a static configuration of contaminated soil using a container arrangement may be provided. The thermal desorption technique can restore the soil to its un-contaminated condition by removing the contamination within the soil through the evaporative desorption process. To provide an efficient remediation process, different temperature settings and different gases can be used to treat different contaminated soil, and thus sample of the contaminated soil can be tested to determine appropriate treatment conditions.

In one or more embodiments, which may be in addition or combination to any other embodiments, the present invention may comprise an ex-situ thermal desorption system or method to remediate contaminants, wherein the treatment may apply the mentioned processes and methods, and wherein the temperature of the gas and heat of the soil and soil treatment box may be of any temperature.

In one or more embodiments, which may be in addition or combination to any other embodiments, the present invention may comprise an ex-situ thermal desorption system or method to remediate contaminants, wherein the treatment may apply the mentioned processes and methods, and wherein the pressure, velocity, and temperature of the treatment gas may be of any value for an effect, and of which may at different points of the system may be appreciated, such as at the insertion points and pipes, the velocity and pressure of the treatment gas may be higher than that of the exit points, such that the treatment gas may flow from the insertion points to the exit points.

In one or more embodiments, which may be in addition or combination to any other embodiments, the present invention may comprise an ex-situ thermal desorption system or method to remediate contaminants, wherein the treatment may apply the mentioned processes and methods, and wherein the soil's time of heating, the time at temperature, or time exposed to the treatment gases may vary for a desired effect, such as to remove a desired amount of contaminants, or to assure that all the soil in the soil box has been heated to a uniform temperature, such that the soil has been uniformly treated, etc.

In one or more embodiments, which may be in addition or combination to any other embodiments, the present invention may comprise an ex-situ thermal desorption system or method to remediate contaminants, wherein the treatment may apply the mentioned processes and methods, and wherein exit point for the desired or evaporated contaminants may be within the upper section of the soil box, such as on a roll-off hopper modified to contain the exit pathway, capturing the evaporated and disrobed contaminates. In the direct heating method, this top may also capture the treatment gas along with the evaporated and desorbed contaminated gas. It may be also noted that while the top of the soil treatment box may be preferred, this exit point may be along any of the sides, as well as on the underside of the box, of which may also be preferred embodiments.

In one or more embodiments, which may be in addition or combination to any other embodiments, the present invention may comprise an ex-situ thermal desorption system or method to remediate contaminants, wherein the treatment may apply the mentioned processes and methods, and wherein the entrance points may be a recess, slot or perforation between the pipe and the interior of the soil treatment box, wherein the gas may enter the interior treatment recess through the slot. Correspondingly, slots between the exit pipes and the interior of the soil treatment box may exist to excavate the gas and evaporated or desorbed contaminants out of the treatment recess.

In one or more embodiments, which may be in addition or combination to any other embodiments, the present invention may comprise an ex-situ thermal desorption system or method to remediate contaminants, wherein the treatment box may include vapor extraction lines at the bottom of the soil box to capture containments, condensed gas, or any other vapor, liquid contaminants or substance to be removed.

In one or more embodiments, which may be in addition or combination to any other embodiments, the present invention may comprise an ex-situ thermal desorption system or method to remediate contaminants, wherein the soil box may be configured so that the thermal energy can travel uniformly from the heating inlet to the exhaust outlet. Different thermal paths from the heating inlet to the exhaust outlet can be similar, e.g., having the same distance and/or thermal gradient. This can allow uniform treatment of the soil, e.g., the contaminated soil material in the soil box can be treated uniformly in different thermal paths, so that the contaminated soil can finish the treatment at a same time. The uniform thermal treatment can eliminate or reduce dead spots or spots with longer heat treatment. The uniformity of heat paths may provide an improved thermal desorption treatment of the contaminated soil, for example, to allow the soil to complete the treatment at a same time, e.g., there may be no section of the soil that need to be treated longer. For example at the beginning, the heat input may be applied to the top portion of the soil. The top portion of the soil may be treated, e.g., contamination evaporated and removed from the soil. The heat wave then travels downward to the next portions of the soil, treating these portions. When the heat wave reaches the bottom of the soil, all soil has been treated. This heating process can represent an optimum time treatment, e.g., ensuring all soil may be treated at the end of the treatment process at a shortest time possible.

In one or more embodiments, which may be in addition or combination to any other embodiments, the present invention may comprise an ex-situ thermal desorption system or method to remediate contaminants, wherein the soil box configuration can include a bottom exhaust that may be similar to the top input. For example, the soil box can have an open top, which may be configured for ease of receiving and removal of contaminated soil material. The open top can be operable as a thermal inlet, accepting hot gas, such as from a heat source, for treating the contaminated soil. The bottom of the soil box can be configured as an exhaust output, thus allowing heat paths to run parallel from the top side to the bottom side of the soil box.

In one or more embodiments, which may be in addition or combination to any other embodiments, the present invention may comprise an ex-situ thermal desorption system or method to remediate contaminants, wherein the soil box the flow conductance through the exhaust output can be substantially similar to the flow conductance through the soil. A hot gas can be provided to the top portion of the soil box, and then the hot gas can travel through the soil to reach the exhaust outlet. There may be a flow conductance through the soil, e.g., the soil represents a resistance to the hot gas flow. The exhaust output can have a flow conductance, for example, determined by the opening of the outlet. In one or more embodiments, the exhaust output can be configured in the form of a screen, with small openings for support the soil, e.g., preventing the soil from entering the exhaust outlet, and for allowing the hot gas to exhaust. The screen can have a mesh size, e.g., screen opening or open area, that may be compatible, e.g., similar, to the conductance through the soil, thus allowing the hot gas to travel through the soil to the exhaust with efficiency.

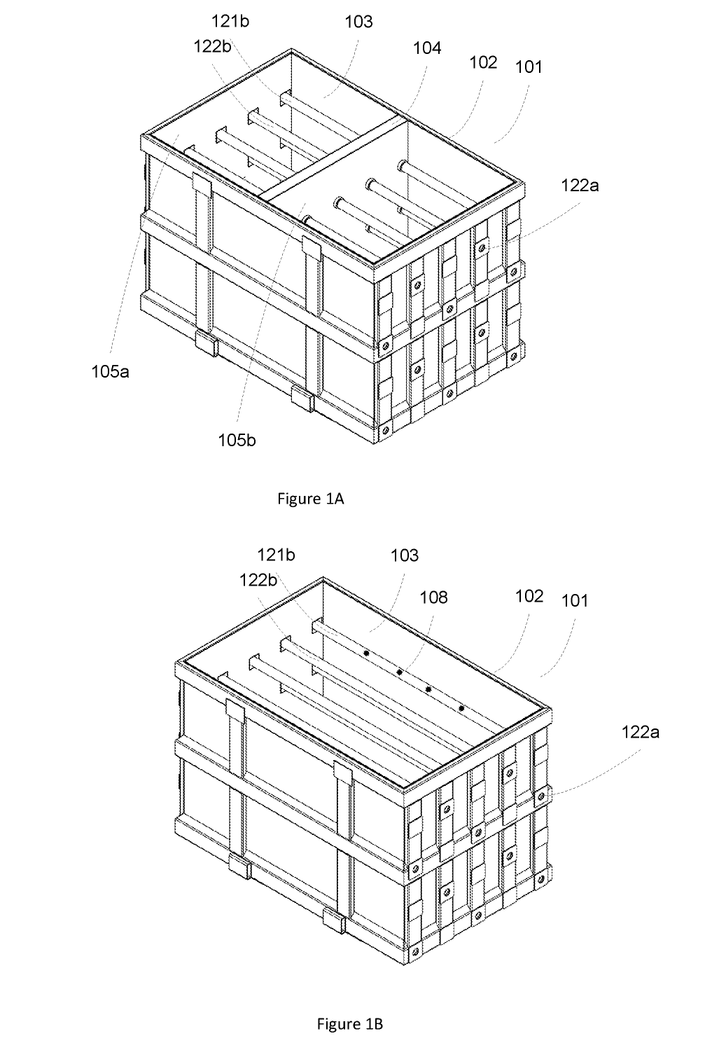

FIG. 1A-1B teaches to side perspective views of embodiments of the present invention.

FIG. 1A teaches to an ex-situ thermal desorption system soil treatment box 101, wherein a box or walled container 102 is able to house soil in an interior treatment recess 103. It is noted that the top of the container in FIG. 1A is removed. The interior recess 103 may be divided into at least two zones, 105a and 105b of which, as aforementioned, may include different characteristics for soil decontamination and remediation. It is noted any plurality of zones may exist. Additionally, pipes 121b and 122b may respectively constitute insertion or inlet and exit or outlet pipes, of which hot gas may travel to either indirectly contact the soil, or of which perforations along the pipe, or at or in the ends of the pipe gas may permeate into the soil. Inlet or exit 122a may connect to a larger shared housing or forced gas system, wherein the treatment gas is sourced, heated and/or processed for use.

FIG. 1B teaches to an ex-situ thermal desorption system soil treatment box, wherein a box or walled container 102 is able to house soil in an interior treatment recess 103. It is noted that the top of the container in FIG. 1B is removed. The interior recess 103 may be of a single zone additionally, pipes 121b and 122b may respectively constitute and inlet and outlet pipes, of which hot gas may travel to either indirectly heat the soil, or, of which perforations 108 along the pipe, or in the ends of the pipe gas may allow the gas to permeate into the soil and heat directly. Inlet or exit 122a, may also connect to a larger shared housing or forced gas system, wherein the treatment gas is sourced, heated and/or processed for use or the treatment gas now used along with the desorbed or evaporated contaminants are processed, vented filter, or otherwise treated or stored.

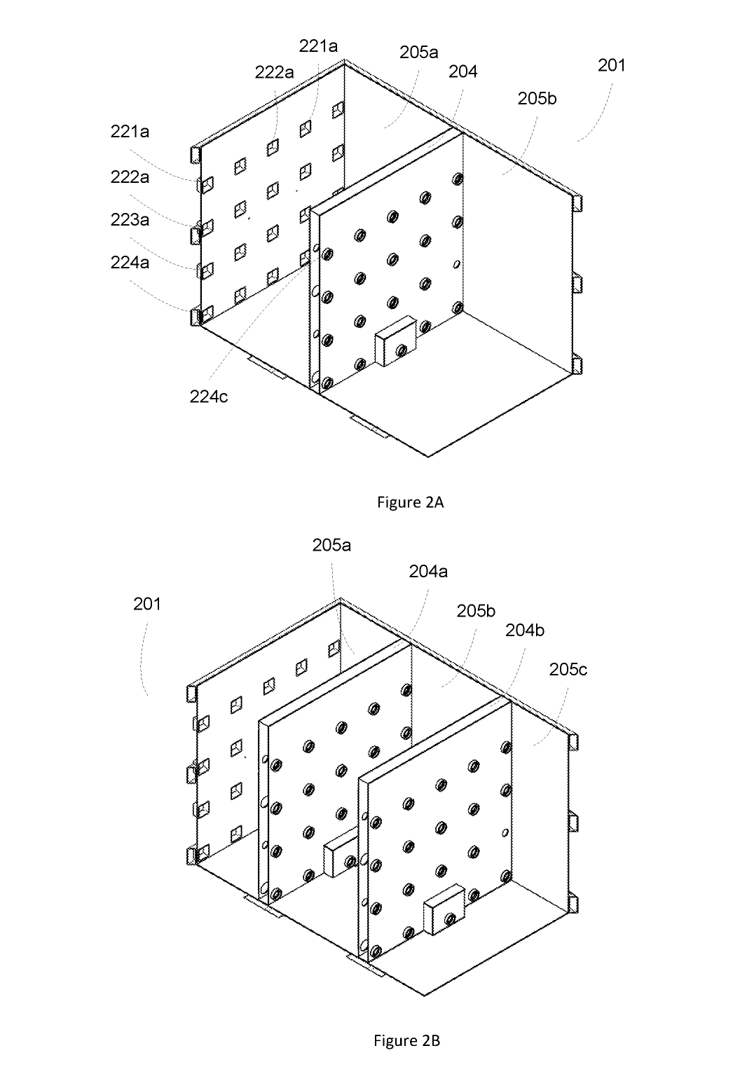

FIGS. 2A-2B teach to a side perspective view of embodiments of the present invention.

FIG. 2A teaches to an ex-situ thermal desorption system soil treatment box 201, wherein the box includes two zones, 205a and 205b split by a wall 204. It is noted that 204 may have recesses such as 224c, wherein the pipes carrying the treatment gas are able to span multiple zones. It is noted that the pipes may be seamless as one piece, or may be multiple sections, of which at the recesses are connected or otherwise made seamless. Of note are insertion and exit recesses 221a, 222a, 223a and 224a, of which may be ports, or of which pipes may enter the interior recess and of which the pipes are sealed, connected, welded or otherwise integrated into the structure of the soil treatment box. It is of note that also the points may alternate insertion and exit duties, such as 221a being an insertion point, 222a being an exit point, 223a, being an insertion point, and 224a being an exit point, such that the pipes running parallel, or the recesses themselves being insertion or exit points, minimizes the insertion and exit distances for the treatment gas to either transfer heat through the pipes to the soil indirectly, or transfer heat or otherwise interact with the soil directly, allowing for total heat transfer and permutation through the soil for effective decontamination, evaporation and desorption of the contaminants. In the direct embodiment specifically, the alternate sides of the soil box, with the insertion points may provide for the gas traveling in alternate directions, where then because the treatment gas is the hottest at the point of insertion, the heat may be more evenly transferred to the soil than if one or all the insertion points were on one side.

FIG. 2B teaches to an embodiment of the present invention soil treatment box 201, wherein the interior of the soil box is broken by interior dividers or walls 204a and 204b into at least three respective zones 205a, 205b, and 205c. It is noted that more zones may also be possible, with more interior dividers that may span the interior recess.

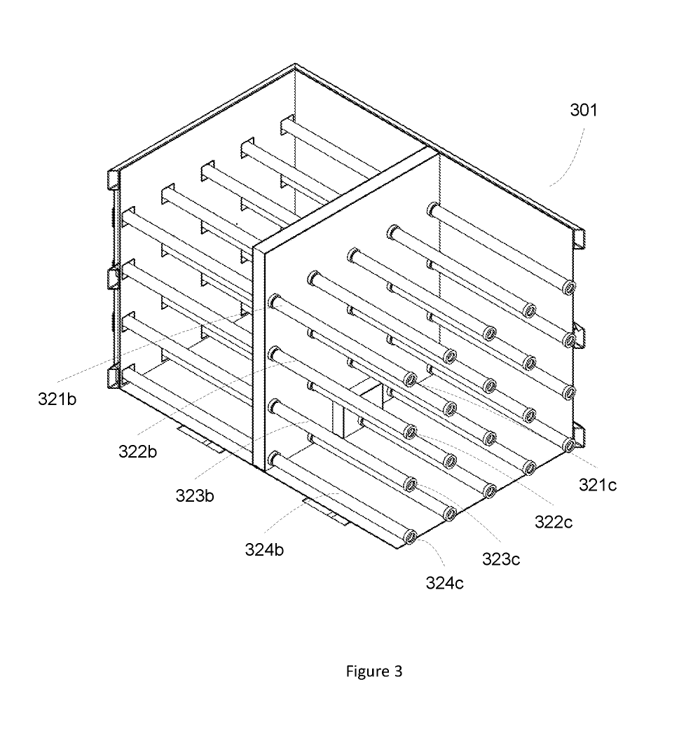

FIG. 3 teaches to a side perspective cross-section of the present invention ex-situ soil treatment box. FIG. 3 displays a soil treatment box 301, of which is noted is internal to that in FIG. 2A, but wherein FIG. 3 includes the pipes present. The pipes may then be arranged in a equidistance cross pattern spacing as displayed, and may alternate then with pipe 321b, corresponding to the insertion point 221a as found in FIG. 2A, pipe 322b, corresponding to the insertion point 222a as found in FIG. 2A, pipe 323b, corresponding to the insertion point 223a as found in FIG. 2A, and pipe 324b, corresponding to the insertion point 224a as found in FIG. 2A. It is then also taught that the order and organization of the pipes as insertion pipes and exit pipes may be alternating to minimize the distance between the insertion and exit gases, as to allow for maximum transfer of heat to the soil. Such then, pipe 321b may use the insertion point 221a as found in FIG. 2A and travel from 221a through pipe 321b and out 321c, and then following in alternating pattern, pipe 322b may use the insertion point 222a as found in FIG. 2A and travel from 222a through pipe 322b and out 322c, additionally pipe 323b may use the insertion point 223a as found in FIG. 2A and travel from 223a through pipe 3223 and out 323c, and additionally, pipe 324b may use the insertion point 224a as found in FIG. 2A and travel from 224a through pipe 324b and out 324c. It is noted that the orientation of the pipes and insert ion and exit points may be of any pattern or shape to maximize efficiency and heat transfer to the soil.

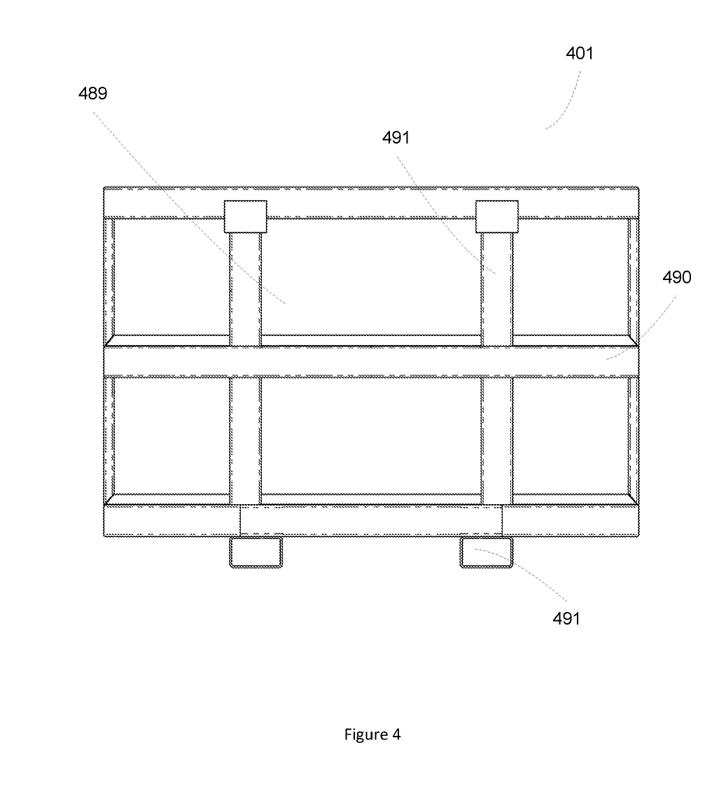

FIG. 4 teaches to a side view of the exterior of an embodiment of the present invention. FIG. 4 displays a soil treatment box 401, wherein the box may be of any shape, geometry, design or material, and of which, in a preferred embodiment, may be a pre-fabricated soil box, shipping container of other container, of which may be modified. The container may include vertical supports 490 and lateral support 491, of which the façade 489 may include blast proofing or other explosion proofing as well as support to handle the weight of the soil and contents. The box may also include ports 491 to accept easy transfer and load by forklift or other lifting device. It is noted that the opposite side may be similar to the current side shown in FIG. 4.

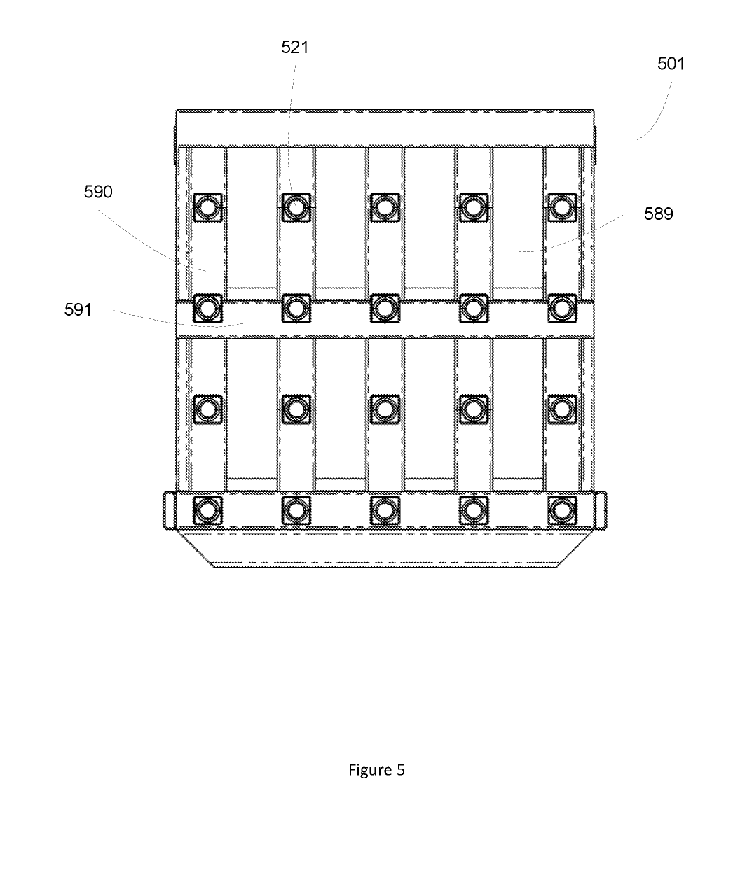

FIG. 5 teaches to another side view the exterior of an embodiment of the present invention. FIG. 5 displays a soil treatment box 501, wherein the box may be of any shape, geometry, design or material, and of which in preferred embodiment may be a pre-fabricated soil box, shipping container of other container, of which may be modified. The container may include vertical supports 590 and lateral support 591, of which the façade 589 may include blast proofing or other explosion proofing as well as support to handle the weight of the soil and contents. It is also noted that a larger hood or plenum may be placed over this side wherein the plenum may feed or force air into the insertion points 521. Additionally a plenum on the alternate side, may allow treatment gas to escape to be treated, processed or otherwise filtered or stored. Additionally the plenum may connect to the alternation insertion points on one side, while another plenum, or a plurality of plenums may connection to the exit points. It is noted that the opposite side may be similar to the current side shown in FIG. 5.

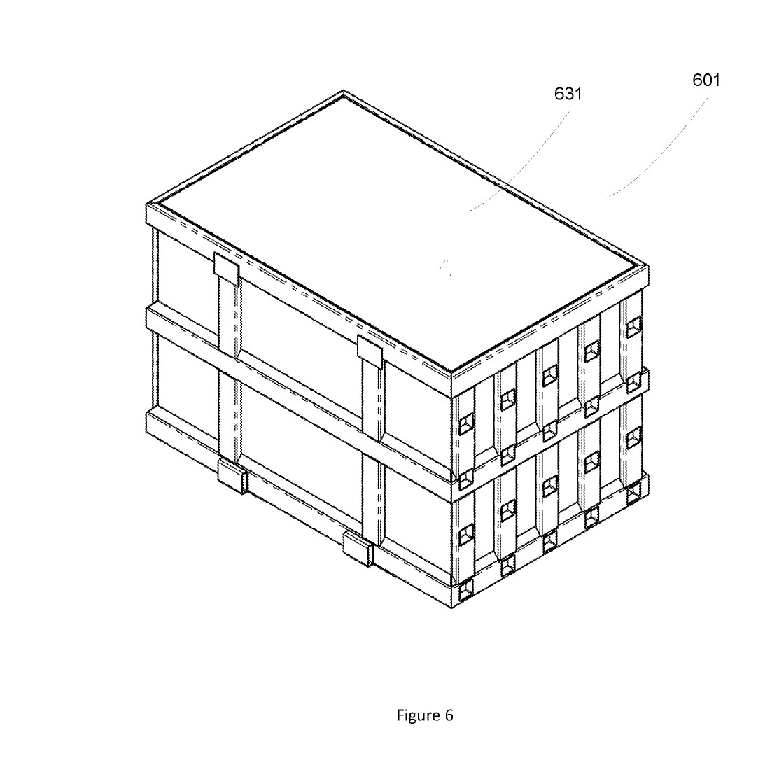

FIG. 6 teaches to a perspective of the exterior of an embodiment of the present invention. FIG. 6 displays a soil treatment box 601, where the soil box may include a removable top 631, of which may be attached by any method, and of which may isolate the interior recess from the ambient at a standard, such that the evaporated or desorbed contaminants as well as treatment gas, if directly in contact with the soil and recess may be captured by the exit points and not vented directly to the atmosphere. The top 631 may be of any design, height and geometry such as a roll type, or may also include a plenum, wherein the gases and evaporated or desorbed contaminants may be captured. The top may also provide for blast protection from auto-ignition of the interior contaminants, soil or treatment gas.

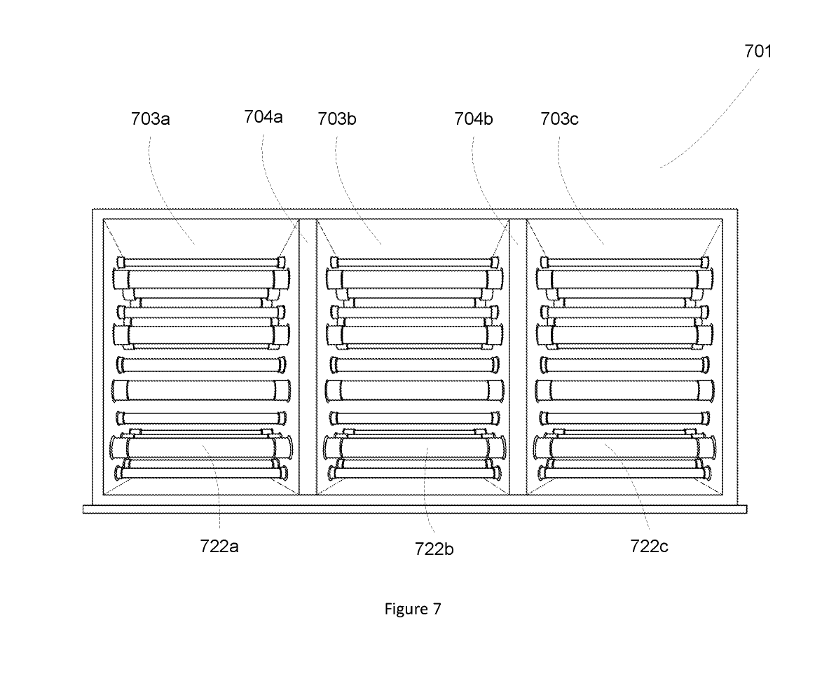

FIG. 7 teaches to a side view cross-section of an embodiment of the present invention. FIG. 7 displays a soil treatment box 701, where interior dividers 704a and 704b creates zones 703a, 703b and 703c in the interior of the box and wherein the pipes are broken into the three sections, running across and penetrating through the dividers, such that pipe sections 722a, 722b and 722c run along the length of the soil box to provide for an insertion point at one end and an exit point at another for the treatment gas.

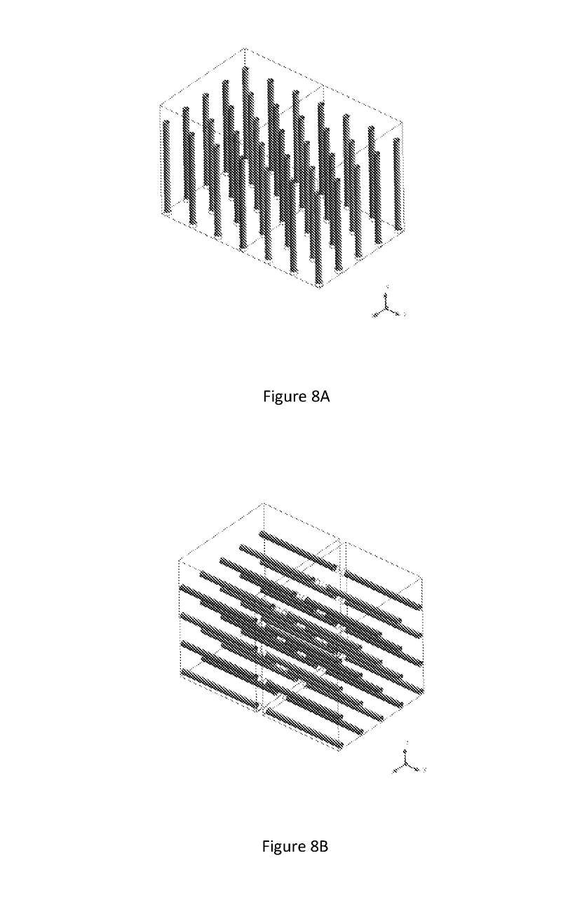

FIGS. 8A-8B teaches to a flow study diagram of the present invention showing treatment gas flowing through the pipes on the interior of the box. It is noted that FIG. 8A present a box in vertical pipe configurations, wherein the pipes are alternating in flow direction. FIG. 8B shows the horizontal alternating flow directions. Studies may be done one specific soils and containments of which the flow diagrams may aid in determining the best velocities, temperatures, pressures and configurations, of which any plurality and type of sensors may be included in the present invention to monitor.

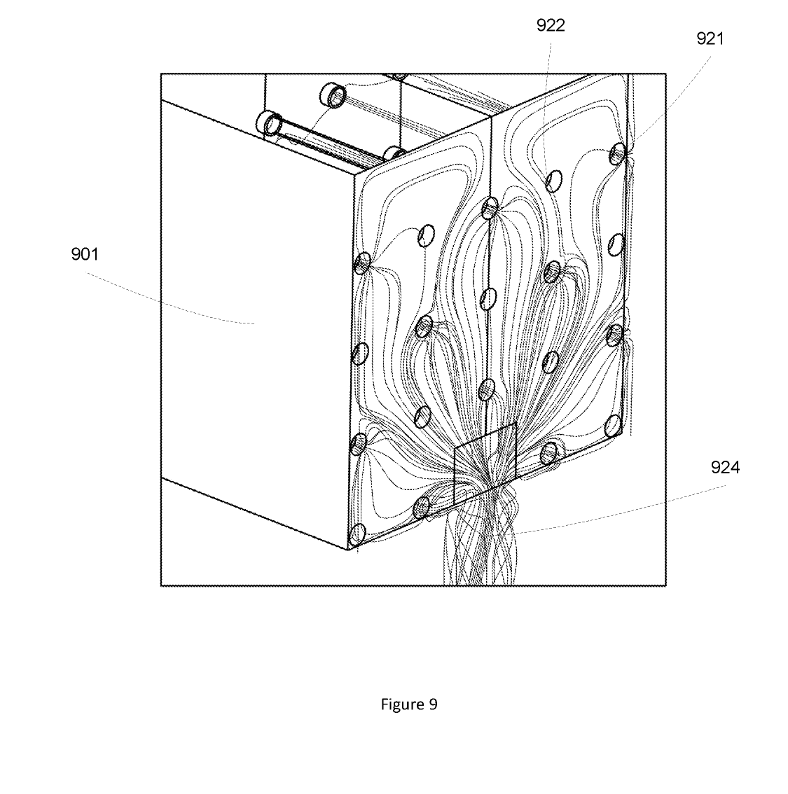

FIG. 9 teaches to an alternate flow study diagram of the present invention. FIG. 9 displays the soil box 901 with flow lines showing treatment gas flowing as a cross action into the insertion points 922. It is noted that exit points are not included in the flow study, but would be as exit points on the alternate side of the soil box. Or conversely the insertion points on the alternate side would line up with the flow absent points in the diagram, such as port 922. It is also noted, that this flow diagram is a cross section flow diagram of an embodiment that does include a not pictured plenum or hood, but as can be seen by the converging airflow at the plenum area 924.

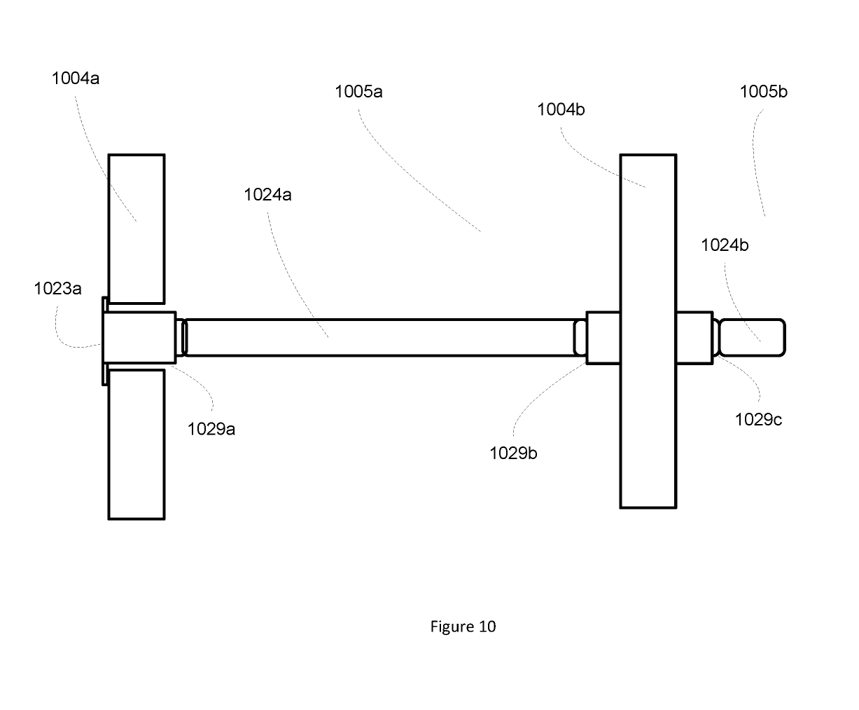

FIG. 10 teaches to a cross section of the present invention ex-situ soil treatment box. FIG. 10 shows a close up cross section of the present invention, where 1004a may be the exterior wall of the treatment box, and wherein combined with the pictured 1004b interior wall, zone 1005a is made. Additionally, wall 1004b, along with the not pictured interior wall or opposite exterior wall 1004c, creates zone 1005b. Insertion or exit port 1023a then can be seen to penetrate the exterior wall 1004a, and of which then connects to pipe section 1024a, of which then penetrates interior wall 1004b to connect to pipe section 1024b. It is then noted that at points 1029a, 1029b and 1029c, or other points along the length of pipe sections 1024 and 1024b, additional perforations or insertion or exit points may exist for which the treatment gas may escape the pipe, such that it contacts the soil. Subsequently, other pipe sections may act as the alternate exit or insertion point, such as gas may travel through the insertion point 1023a, into the pipe sections 1024a and 1024b and out of insertions points 1029a, 1029b, and 1029c, wherein the gas may then interact with the soil and of which then the heat and gas may evaporate, or desorb the containments, and wherein the gas along with the contaminants may then travel either through a centralized, plenum such as at the top of the container or alternately, back through an exit pipe section, of which the process may be similar to the above insertion, just in reverse, such as the gas may then exit into the pipe section by exit points 1029a, 1029b or 1029c into the pipe 1024a or 1024b, and then out of the exit point 1023a to be captured, processed, vented or otherwise processed. It is noted that in some embodiments, the treatment gas is used as an indirect method, and of which then the insertion points 1029a, 1029b and 1029c are not present and of which then, the gas enters through insertion point 1023a and travels along the pipe sections 1024a and 1024b until it reaches a corresponding not pictured exit point, of which is similar to the insertion point 1023a on the opposite side. It is also noted that perforations of any size, geometry or type may exist along the body of pipes 1024a and 1024b, wherein the gas may be inserted into the interior recess to interact with the soil and then of which a similar structure to the pipes 1024a and 1024b, of which may be exit pipes, to excavate the gas and containments out of the interior recess.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A soil treatment system, comprising:
a soil box, wherein:
the soil box is able to be filled with a contaminated soil;
the soil box has at least one gas insertion point on at least one side, wherein:
the insertion point accepts a heated treatment gas;
the soil box has at least one gas exit point on at least one side, wherein
the exit point exits a treatment gas;
the soil box has at least one pipe connecting points on one side and a corresponding point on an opposite side, and
the heat decontaminates the soil;

2. A system as in claim 1, wherein:
the heat desorbs or evaporates the containments in the soil.

3. A system as in claim 1, wherein:
the heat catalyzes reactions in the soil causing decontamination of the soil and desorption/evaporation of the contaminants.

4. A system as in claim 1, wherein:
at least one side of the soil box has a collection point for evaporated/desorbed contaminants to be removed from the soil box.

5. A system as in claim 1, wherein:
the insertion points, exit points, and pipes are arranged in a grid.

6. A system as in claim 1, wherein:
the treatment gas heats the soil indirectly, wherein as the treatment gas flows from the insertion point, through the pipe, and to the exit point, the treatment gas transfers heat to the pipe, wherein the pipe transfers heat to the contaminated soil.

7. A system as in claim 6, wherein:
the insertion points, exit points, and pipes are arranged such that the proximate insertion point, exit point, and pipe flow the treatment gas in opposite directions.

8. A system as in claim 1, wherein:
at least one of the pipes is an insertion pipe connected to an insertion point on one side of the soil box and plugged on the opposite side, wherein the insertion pipe has perforations or recesses along the pipe length, wherein treatment gas exit the pipe into the soil box to contact the soil directly, and
at least one of the pipes is an exit pipe connected to an exit point on one side of the soil box and plugged on the opposite side, wherein the exit pipe has perforations or recesses along the pipe length, wherein treatment gas and contaminants enter the pipe to be removed from the soil box.

9. A system as in claim 8, wherein:
the treatment gas directly contacting the soil provides as a catalyst for evaporation/desorption of the containments, in addition to the heat.

10. A system as in claim 8, wherein:
the treatment gas heats the soil directly, wherein as the treatment gas flows from the at least one insertion point, through the at least one insertion pipe, enters the soil box, transfers heat to the soil directly, flows into the at least one exit pipe along with contaminants and is removed from the soil box.

11. A system as in claim 1, wherein:
the soil box has at least one interior wall, wherein:
the wall divides the interior of the soil box into zones.

12. A system as in claim 10, wherein:
the at least one pipe penetrates the wall, such that the pipe spans across multiple zones.

13. A system as in claim 10, wherein:
the at least one pipe is plugged at the wall, such that each pipe only spans a respective zone.

14. A system as in claim 1, wherein:
the treatment gas is indirectly/directly heated gas.

15. A system as in claim 1, wherein:
the treatment gas is desiccated ambient air.

16. A system as in claim 1, wherein:
the treatment gas is reused after treatment.

17. A system as in claim 1, wherein:
the evaporated contaminants are vented to the ambient;
wherein the evaporated contaminants are further processed;
wherein the treatment gas is heated below auto ignition temperature.

18. A system as in claim 1, wherein:
the soil box structure includes blast proofing in case that the treatment gas is heated above auto ignition temperature.

19. A system as in claim 1, wherein:
the soil is kept at a temperature for a set period of time, wherein the time at temperature ensures the contaminants are evaporated/desorbed from the soil.

20. A system as in claim 1, wherein:
the heat transferred to the soil diffuses from the pipes in heat waves, such that at a given time, the heat has spread evenly throughout the contaminated soil.
